(19) United States
(12) Patent Application Publication
(10) Pub. No.: US 2025/0373194 A1
(43) Pub. Date: Dec. 4, 2025

(54) INSTALLATION OF PHOTOVOLTAIC TRACKERS BETWEEN AND/OR ATOP GREENHOUSES

(71) Applicant: SOLARGIK LTD, JERUSALEM (IL)

(72) Inventors: Gil KROYZER, Jerusalem (IL); Israel KROIZER, Jerusalem (IL); Efrat Zocher Arica, Jerusalem (IL); Eyal ROSENWEIN, Mazkeret Batya (IL); Boaz Grosman, Mevaseret Zion (IL); Yehoshua GRANTZ, Mevaseret Zion (IL)

(21) Appl. No.: 18/896,962

(22) Filed: Sep. 26, 2024

Related U.S. Application Data
(63) Continuation of application No. PCT/IB2024/055406, filed on Jun. 3, 2024.

(51) Int. Cl. H02S 20/32; H02S 20/22

(52) U.S. Cl. CPC H02S 20/32; H02S 20/22

(57) ABSTRACT

A photovoltaic (PV) assembly is adapted for installation between laterally adjoining or adjacent greenhouses that comprise respective longitudinally aligned pluralities of transverse structural ribs. The PV assembly comprises (i) a frame subassembly and an array of PV panels joined thereto and pivotable therewith about a longitudinal axis of the PV assembly, and (ii) a longitudinally aligned plurality of load-bearing support subassemblies, each configured for attachment to a respective pair of opposing structural ribs of the adjoining or adjacent greenhouses.

### CROSS-REFERENCE TO RELATED APPLICATIONS

This patent application is a continuation of PCT Patent Application No. PCT/IB2024/055406, filed Jun. 3, 2024, which is incorporated by reference herein in its entirety.

### FIELD OF THE INVENTION

The present invention relates to solar energy systems and in particular to mechanical arrangements facilitating installation of photovoltaic (PV) trackers atop greenhouse structures.

BACKGROUND

Achieving a diversified low-carbon emissions energy economy has been limited by economic and technological limitations. Solar energy systems comprising photovoltaic (PV) arrays are commonly deployed to capture energy from both direct and diffuse (including reflected) solar irradiance. Tracking PV systems are deployed in which PV arrays are pivoted to reduce the cosine losses of the direct irradiance component, so-called because the energy absorbed is a function of the cosine of the angle.

Efficient integration of PV assemblies on agricultural land can provide synergies in utilization of land, sun and water. However, commercially available PV systems designed for ground mounting, and amongst them the tracking PV systems that are becoming more widespread, are generally not compatible with sharing space efficiently with greenhouse buildings. Greenhouses are commonly used in areas with abundant sunshine, and it would be beneficial to exploit a portion of the solar resource available to greenhouses for electricity generation. Various approaches have been suggested for integrating photovoltaic assemblies with open agriculture, but there is a need for new approaches that would enable the space-efficient integration of PV assemblies with closed greenhouses.

### SUMMARY

The embodiments herein disclose a photovoltaic (PV) assembly adapted for installation above and/or between laterally adjoining or adjacent greenhouses comprising respective longitudinally aligned pluralities of transverse structural ribs. The PV assembly comprises (i) a frame subassembly and an array of PV panels joined thereto and pivotable therewith about a longitudinal axis of the PV assembly, and (ii) a longitudinally aligned plurality of load-bearing support subassemblies, each configured for attachment to a respective pair of opposing structural ribs of the adjoining or adjacent greenhouses.

In some embodiments, attachment of the plurality of load-bearing support subassemblies to respective pairs of opposing structural ribs is effective to transfer a portion of the weight of the PV assembly to the structural ribs. In some embodiments, attachment of the plurality of load-bearing support subassemblies to respective pairs of opposing structural ribs is effective to transfer the entire weight of the PV assembly to the structural ribs.

In some embodiments, it can be that each of the load-bearing support subassemblies includes (i) a primary support member pivotably coupled to the frame assembly, and (ii) a secondary support assembly comprising a secondary support member rigidly connected to the primary support member and configured for attachment to the respective pair of opposing structural ribs. In some such embodiments, it can be that the primary support member is oriented vertically or within ±30° of vertical, the secondary support member is oriented horizontally or within ±30° of horizontal, and a long axis of the secondary support assembly is oriented transversely to the longitudinal axis or within ±30° of transverse.

In some embodiments, it can be that at least one of a long-axis length of the secondary support assembly and an orientation angle of a long-axis end thereof is mechanically adjustable.

In some embodiments, the plurality of load-bearing support subassemblies collectively support the frame subassembly and the array of PV panels joined thereto.

In some embodiments, the PV assembly can comprise a drive system mounted to a selected one of the load-bearing support subassemblies and operative when powered to pivot the frame subassembly and the array of PV panels joined thereto; the primary member of the selected one of the load-bearing support subassemblies can be larger in at least one transverse cross-sectional dimension than respective primary members of all other load-bearing support subassemblies of the plurality of load-bearing support subassemblies.

According to the embodiments disclosed herein, a PV assembly comprises (i) a frame subassembly and an array of PV panels joined thereto and pivotable therewith about a longitudinal axis of the PV assembly, and (ii) a longitudinally aligned plurality of load-bearing support subassemblies. Each load-bearing support subassembly comprises: (i) a vertical member pivotably coupled to the frame assembly, and (ii) a horizontal-member assembly comprising a horizontal member rigidly connected to the vertical member such that a long axis of the horizonal-member assembly is transverse to the longitudinal axis, at least one of a length of the horizontal-member assembly and an orientation angle of a laterally disposed end thereof being mechanically adjustable.

A method is disclosed, according to embodiments, for joining one or more PV assemblies to an array of laterally adjoining or adjacent greenhouses. The method comprises: providing a PV assembly comprising (i) a frame subassembly and an array of PV panels joined thereto and pivotable therewith about a longitudinal axis of the PV assembly, and (ii) a longitudinally aligned plurality of load-bearing support subassemblies spaced apart longitudinally to align laterally with respective transverse structural ribs of two adjoining or adjacent greenhouses, wherein each of the load-bearing support subassemblies includes (i) a primary support member pivotably coupled to the frame assembly, and (ii) a secondary support assembly comprising a secondary support member rigidly connected to the vertical member. The method further comprises: attaching the respective secondary support assemblies of the load-bearing support assemblies to opposing pairs of structural ribs of the two adjoining or adjacent greenhouses.

In some embodiments of the method, the attaching can be effective to transfer the load of the entire weight of the frame subassembly and of the array of PV panels joined thereto to the structural ribs. In some embodiments of the method, it can be that the primary support member is oriented vertically or within ±30° of vertical, the secondary support member is horizontal or within ±30° of horizontal, and a long axis of the secondary support assembly is transverse to the longitudinal axis or within ±30° of transverse. In some embodiments, the method additionally comprises: mechanically adjusting at least one of a long-axis length of the secondary support assembly and an orientation angle of a long-axis end thereof.

According to embodiments disclosed herein, a structural arrangement comprises: (a) an array of laterally adjoining or adjacent greenhouses comprising respective longitudinally aligned pluralities of transverse structural ribs; and (b) a PV assembly comprising (i) a frame subassembly and an array of PV panels joined thereto and pivotable therewith about a longitudinal axis of the PV assembly, and (ii) a longitudinally aligned and spaced-apart plurality of load-bearing support subassemblies each including a vertical member pivotably coupled to the frame assembly and rigidly connected to a horizontal member of a horizontal-member assembly, the rigid connection being such that a long axis of the horizonal-member assembly is transverse to the longitudinal axis. The respective horizontal-member assemblies of the load-bearing support assemblies are attached to opposing structural ribs of two adjoining or adjacent greenhouses, the attachment being such that the weight of the PV assembly is supported by the structural ribs.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a block diagram of a drive-system controller for a solar energy system, according to embodiments of the present invention.

FIGS. 3, 4A, 4B and 4C are schematic illustrations of greenhouses.

FIG. 5 shows a schematic perspective view of selected components of a PV assembly, according to embodiments of the present invention.

FIGS. 6A and 6B are schematic illustrations of support subassemblies of a PV assembly, according to embodiments of the present invention.

FIG. 7 shows a schematic side view of selected components of a PV assembly, according to embodiments of the present invention.

FIGS. 8 and 9 show schematic end-view and perspective-view illustrations, respectively, of a PV assembly installed atop respective structural ribs of adjacent greenhouses, according to embodiments of the present invention.

FIG. 10 shows a schematic illustration of PV assemblies arranged between adjacent greenhouses, according to embodiments of the present invention.

FIG. 11 is a schematic illustration of a support subassembly of a PV assembly according to embodiments of the present invention.

FIG. 12 shows a schematic illustration of a portion of a PV assembly installed atop respective structural ribs of adjacent greenhouses, according to embodiments of the present invention.

FIGS. 13 and 14 show flowcharts of a method and method steps for joining one or more PV assemblies to an array of laterally adjoining or adjacent greenhouses, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Note: Throughout this disclosure, subscripted reference numbers (e.g., 10₁ or 10_{A}) may be used to designate multiple separate appearances of elements of a single species, whether in a drawing or not; for example: 10₁ is a single appearance (out of a plurality of appearances) of element 10. The same elements can alternatively be referred to without subscript (e.g., 10 and not 10₁) when not referring to a specific one of the multiple separate appearances, i.e., to the species in general.

A ‘solar energy system’ as used herein means a system for generating electricity using an array of photovoltaic (PV) panels or modules. The system can include an inverter for converting the direct-current (DC) electricity generated by the PV modules to alternating current (AC) electricity, e.g., for delivery to an electricity grid. Embodiments disclosed herein relate to apparatuses and systems for operating a solar energy system incorporating a solar tracker. A solar tracker, or simply ‘tracker’ or ‘PV tracker’, is a PV assembly having a powered arrangement that changes the attitude of the PV panels so as to capture, i.e., convert, a higher proportion of the direct irradiance falling on the panels over the course of any given period of time by reducing the angle between direct solar radiation and a vector normal to the PV panels. A single-axis tracker is one that rotates PV panels around a single axis, usually from east to west over the course of a day around a north-south axis. Some single-axis trackers are arranged to rotate about an east-west axis.

Embodiments of the invention relate to a solar energy system comprising one or more PV assemblies are installed between, and generally atop, adjoining or adjacent greenhouses. Greenhouses often differ from other structures in that they are constructed from glass, plastic or cloth panels installed on or between, or stretched over, a series of structural ribs defining the profile of the greenhouse. According to the disclosed embodiments, PV assemblies are adapted for attachment to the structural ribs of the greenhouses by means of load-bearing sub-assemblies lined up beneath the PV panels.

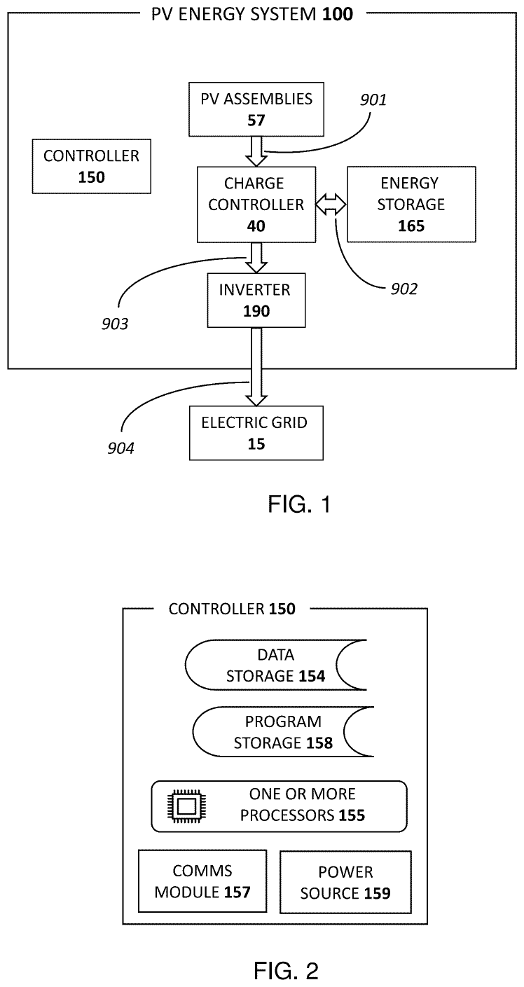

Referring now to the figures, and in particular to FIG. 1, a solar energy system 100 according to embodiments includes one or more PV assemblies 57. In embodiments, the PV assemblies 57 can be of the fixed-plate array variety or can include tracking component, i.e., a drive system 110, for increasing cumulative electricity generated over the course of a period of time.

The solar system 100 of FIG. 1 additionally includes an inverter 190. An inverter can include electronic circuitry, for example for synchronizing the phase, and for matching the voltage and frequency of the power output to those of the grid. In some embodiments, the solar energy system 100 can include an energy storage device 165 of FIG. 1, which can include a rechargeable battery or capacitor and can be used, e.g., to ‘smooth’ the output of the PV assemblies 57. A charge controller 40 can be provided to mediate between the PV array 110, the inverter 190, and the energy storage device 165, to regulate the charging and discharging processes of the energy storage device 165 and to ensure correct charging and prevent overcharging. A drive-system controller 150 and charge controller 40 are shown schematically for purpose of illustration as separate elements; however, in some embodiments, the control system 150 and charge controller 40 form a single integrated unit. In some embodiments, the charge controller 40 can located in, and/or integrated in, the inverter 190.

FIG. 1 further illustrates a non-limiting example of a power flow scheme for a solar energy system 100: power generated by the PV array 110 flows to the charge controller 40 as indicated by arrow 901. Two-way power flow takes place between the charge controller 40 and the energy storage device 165, as indicated by two-way arrow 902. Power from the PV array 110 and the energy storage device 165 flows through the charge controller 40 to the inverter 190, as indicated by arrow 903. The inverter 190 delivers energy to the electric grid 15, as indicated by arrow 904.

Referring now to FIG. 2, a drive-system controller 150 according to embodiments is illustrated schematically to show selected components. The exemplary control system 150 of FIG. 2 includes one or more computer processors 55, a computer-readable storage medium 58, a communications module 57, and a power source 59. The computer-readable storage medium 58 can include transient and/or transient storage, and can include one or more storage units, all in accordance with desired functionality and design choices. The storage 58 can be used for any one or more of: storing program instructions, in firmware and/or software, for execution by the one or more processors 55 of the controller 150. In embodiments, the stored program instructions include program instructions for operating the solar energy system 100. Data storage 54, if separate from storage 58, can be provided for historical data, e.g., actual irradiance and/or forecast values, and other data related to the operation of the solar energy system 100. In some embodiments, the two storage modules 54, 58 form a single module. A communications module 59 is configured to establish communications links with other components of the solar energy system 100 and/or one or more external computers. In some embodiments, a controller 150 does not necessarily include all of the components shown in FIG. 2. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as . CAN bus (Controller Area Network, Fieldbus, Fire Wire, HyperTransport and InfiniBand.

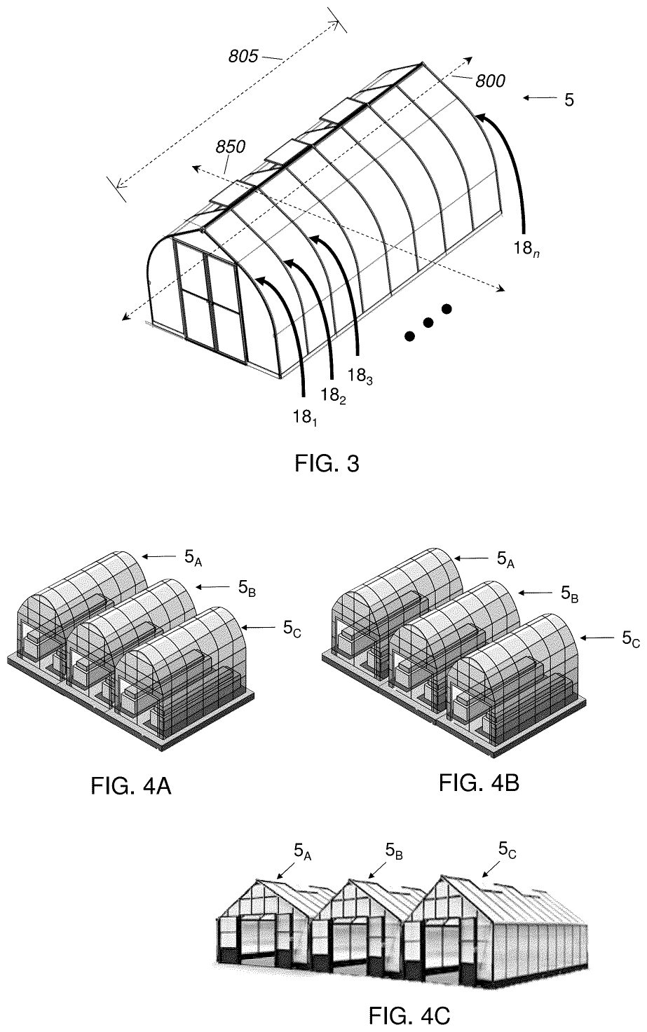

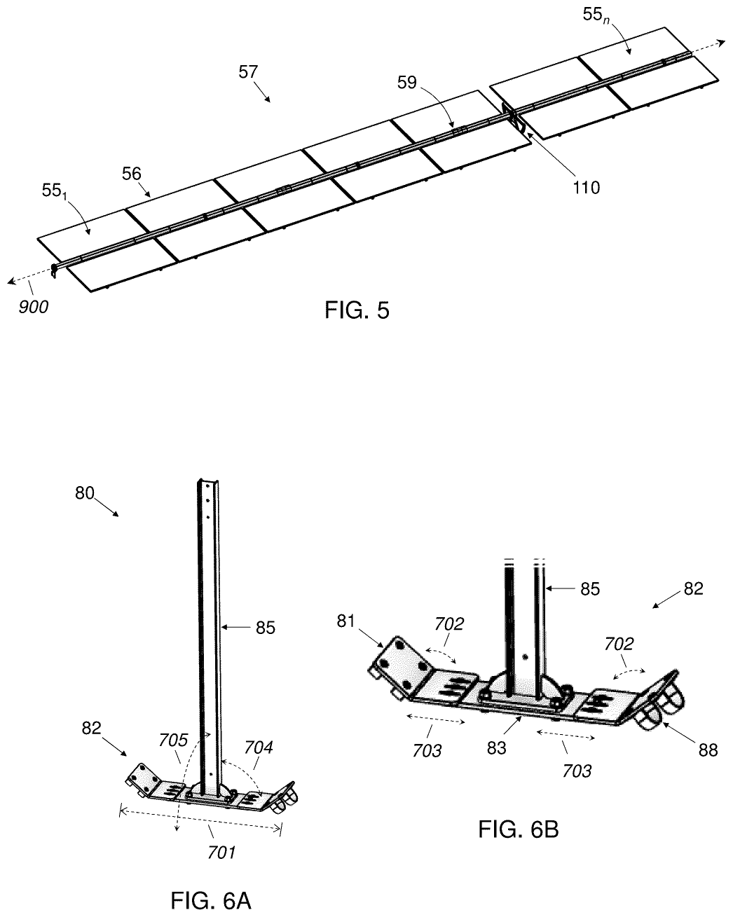

FIGS. 3 and 4A-C illustrate exemplary greenhouses which are suitable for use with PV assemblies disclosed herein. FIG. 3 shows a greenhouse 5 built around a series of n structural ribs 18 spaced apart longitudinally, i.e., in the direction indicated in FIG. 3 by arrow 800, along the length, indicated in FIG. 3 by arrow 805, of the greenhouse 5. The individual ribs 18₁ . . . 18ₙ are transverse (orthogonal) to the longitudinal direction 800, the transverse direction being indicated in FIG. 3 by arrow 850. The ribs can be of any practical shape, e.g., curved or straight, arched or angled, etc., and are not limited to the illustrative examples in the figures. FIGS. 4A and 4B show further examples of curved, arched ribs 18. The three illustrated greenhouses 5_{A}, 5_{B}, 5_{C} are adjoining in FIG. 4A and adjacent to each other in FIG. 4B, i.e., in proximity but not necessarily touching. FIG. 5 illustrates three greenhouses 5_{A}, 5_{B}, 5_{C} having straight, angled ribs 18.

FIG. 5 shows an exemplary PV assembly 57 employing single-axis tracking. The PV assembly 57 of FIG. 5 includes n PV panels 55₁ through 55ₙ, mounted to respective frames 56 joined to a central elongated member 59. The central elongated member 59 serves to transfer a torque to rotate the frames 56 as a unit together with the central elongated member 59 and the PV panels 55. The PV assembly 57 is rotated about a central longitudinal axis indicated in FIG. 5 by dashed line 900. The central elongated member 59 is pivotably supported by load-bearing support assemblies (not visible in the top perspective view of FIG. 5), as will be further discussed hereinbelow. A drive system assembly 100 according to embodiments includes a motor assembly and optionally a pivot wheel or other mechanism for transmitting torque. The drive system 40 can be located in the center of the PV assembly 57, or, as shown in the non-limiting example of FIG. 5, can be located elsewhere along the length of the PV assembly 57.

FIG. 6A shows an exemplary load-bearing support assembly 80 according to embodiments. The load-bearing support subassembly 80 includes a primary support member 85 and a secondary support assembly 82 rigidly connected to the primary support member 81. In some embodiments, the primary support member 85 is vertical and the secondary support assembly is horizontal, meaning that the primary support member 85 is rigidly connected to a horizontal portion or horizontal member of the secondary support assembly 82. Being at a ‘vertical’ orientation has the meaning herein of having an orientation such that the top is directly above the bottom. Being at a ‘horizontal’ orientation has the meaning herein of (i) being at a right angle to the vertical and/or of (ii) being parallel to the plane of the horizon. In some embodiments, the primary support member 85 is not exactly vertical but at an angle within ±5° of vertical, or within ±10° of vertical, or within ±15° of vertical, or within ±20° of vertical, or within ±25° of vertical, or within ±30° of vertical, or within ±35° of vertical, or within ±40° of vertical, or closer to the vertical orientation than to the horizontal orientation. The illustrations in the figures are idealized to show all primary support members 85 as being exactly vertical, but this is merely for convenience and is not limiting, and the primary support members 85 can be at any orientation in any one of the foregoing orientation ranges as desirable or suitable for supporting the load of the PV assembly 57 and/or transferring the load to the structural ribs 18 of the adjoining or adjacent greenhouses 5. In some embodiments, the secondary support assembly 82 is not exactly horizontal but at an angle within ±5° of horizontal, or within ±10° of horizontal, or within ±15° of horizontal, or within ±20° of horizontal, or within ±25° of horizontal, or within ±30° of horizontal, or within ±35° of horizontal, or horizontal ±40° of vertical, or closer to the horizontal orientation than to the vertical orientation. The illustrations in the figures are idealized to show all secondary support assemblies 82 as being exactly horizontal, but this is merely for convenience and is not limiting, and the secondary support assemblies 82 can be at any orientation in any one of the foregoing orientation ranges as desirable or suitable for supporting the load of the PV assembly 57 and/or transferring the load to the structural ribs 18 of the adjoining or adjacent greenhouses 5.

The angle at which the primary support member 85 is connected to the secondary support assembly 82 is shown in the figures as being a right angle in each of the respective planes indicated by arrows 704 and 705 in FIG. 6A, but this is merely illustrative and is not limiting. In some embodiments, the angle of connection between the primary support member 85 and the secondary support assembly 82—in either or both of the two indicated planes—is not exactly a right angle but angle between 85° and 95°, or between 80° and 100°, or between 75° and 105°, or between 70° and 110°, or between 65° and 115°, or between 60° and 120°.

Further, the rotation from vertical of the primary support member 85 and the rotation from horizontal of the secondary support assembly 82 are not necessarily causatively related, as the reasons for deviation (or lack thereof) from vertical and horizontal may be different. In a non-limiting example, adjoining or adjacent greenhouses are of different heights, or are erected on sloped or terraced land so as to produce an effective difference in heights. In such an example, the secondary support assembly 82 might be rotated from horizontal to more effectively transfer weight of the PV assembly 57 to the respective structural ribs 18 of both greenhouses, while the primary support member 85 may or may not be rotated from vertical. In another non-limiting example, the orientation of the primary support member 85 is determined at least in part by prevailing winds and/or other external constraints or forces. In another non-limiting example, the orientations of the primary support member 85 and of the secondary support assembly are set in according with a static force analysis, a finite-element analysis, or any other analysis of static and/or dynamic forces.

In some implementations, the secondary support assembly 82 comprises multiple members, as in the example of FIG. 6B, which is an expanded detail of FIG. 6A. In the non-limiting example of FIG. 6B, the secondary support assembly 82 includes a secondary support member 83 and two laterally-disposed (i.e., transversely disposed) end portions 81. In some implementations (not illustrated), the secondary support assembly 82 comprises a single member. In some embodiments, the length of the secondary support assembly 82 (in the traverse direction), indicated in FIG. 6A as length arrow 701, can be extended or shortened by mechanical adjustment. The two laterally-disposed end portions 81 of FIG. 6B are slidably installed on the central secondary support member 83 so as to facilitate the mechanical length adjustment, as indicated by arrows 703 in FIG. 6B. In some embodiments, respective orientation angles of the laterally-disposed end portions 81 (i.e., relative to the central secondary support member 83) are mechanically adjustable, as indicated by arrows 702 in FIG. 6B. In some embodiments, the secondary support assembly 82 includes attachment accessories for facilitating attachment to the structural rib 18 of the greenhouse 5, such as, for example, the ring-shaped rib clamps 88 shown in FIG. 6B.

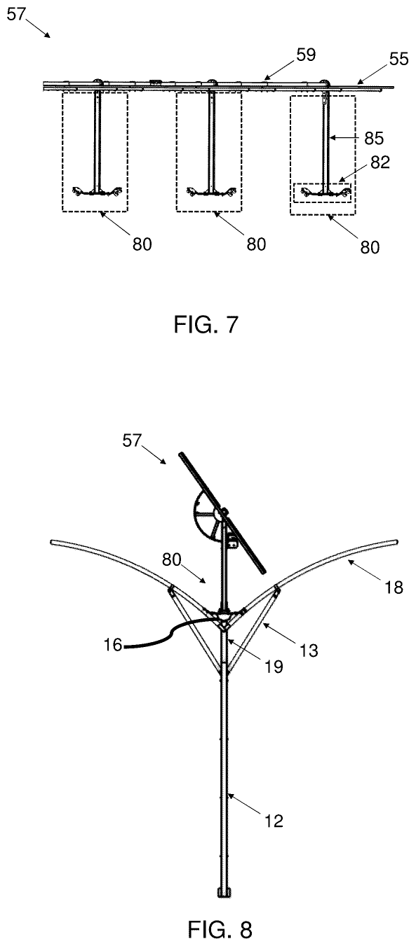

In FIG. 7, a partial-length side view of a PV assembly 57 shows a plurality of load-bearing support subassemblies 80 installed so that the respective primary support members 85 are pivotably coupled to the frame assembly.

A schematically drawn end view of a PV assembly 57 mounted between and atop two adjoining greenhouses 5 is shown in FIG. 8. Only a first load-bearing support subassembly 80 and a first pair of opposing structural ribs 18 are visible in this view, out of a longitudinally aligned plurality of load-bearing support subassemblies 80 attached to respective pairs of opposing structural ribs 18 of the adjoining or adjacent greenhouses 5. As can be seen, the load-bearing support subassembly 80 is attached to respective structural ribs 18. In this exemplary implementation, the ribs 18 of the two adjoining greenhouses 5 meet at a single vertical support 19; this is a function of greenhouse design and construction. Further to the exemplary implementation and addition of the load of the PV assembly 57, the vertical support 19 is supplemented for structural reasons by an added ground support 12, and a pair of struts 13 is added between the vertical support 19 and the ribs 18, which bear some or all of the weight of the PV assembly. The skilled artisan will understand that deploying additional support members and stability struts in the greenhouse depends, inter alia, on the structural strength of the ribs, and other support arrangements may be necessary or, alternatively, none at all. In some greenhouse designs, a rain gutter is installed above the point where two adjoining greenhouses 5 meet; in FIG. 8 it can seen that the load-bearing support subassembly 80 does not interfere with the placement of the gutter 16.

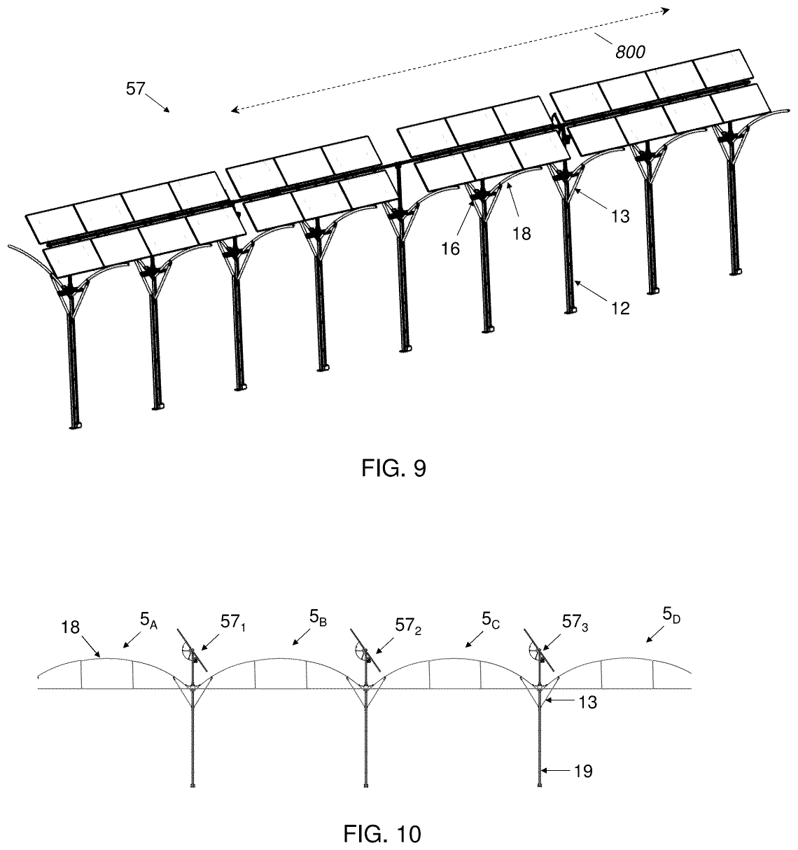

FIG. 9 shows a partial perspective view of the PV assembly 57 of FIG. 8 along with the ribs 18 and supports 19, 13, 12 of the two adjoining greenhouses 5. Arrow 800 in FIG. 9 indicates the same longitudinal direction as in FIG. 3. In embodiments, attachment of the plurality of load-bearing support subassemblies 80 to respective pairs of opposing structural ribs 18 is effective to transfer a portion of the weight of the PV assembly 57 to the structural ribs 18. In some embodiments, attachment of the plurality of load-bearing support subassemblies 80 to respective pairs of opposing structural ribs 18 is effective to transfer the entire weight of the PV assembly 57 to the structural ribs 18.

FIG. 10 shows a schematic end view of an array of laterally adjoining or adjacent greenhouses 5_{A}, 5_{B}, 5_{C} and 5_{D} comprising respective longitudinally aligned pluralities of transverse structural ribs 18. Multiple PV assemblies 57₁, 57₂, 57₃ are arranged, together with the greenhouses, in a single structural arrangement. While not shown, each of the PV assemblies 57 is adapted for installation between the adjoining greenhouses 5 in that it comprises a frame subassembly and an array of PV panels 55 joined thereto and pivotable therewith about a longitudinal axis 900 of the PV assembly 57. Each of the PV assemblies 57 additionally comprises a longitudinally aligned and spaced-apart plurality of load-bearing support subassemblies 80 each including a vertical member 85 pivotably coupled to the frame assembly and rigidly connected to a horizontal member 83 of a horizontal-member assembly 82. The rigid connection is such that a long axis of the horizonal-member assembly 82 (and/or of the central horizontal member 83) is transverse to the longitudinal axis 900. The structural arrangement is characterized by the respective horizontal-member assemblies 82 of the load-bearing support assemblies 80 being attached to opposing structural ribs 18 of two adjoining or adjacent greenhouses 5. The attachment is such that the weight of the PV assembly 57 is supported by the structural ribs 18.

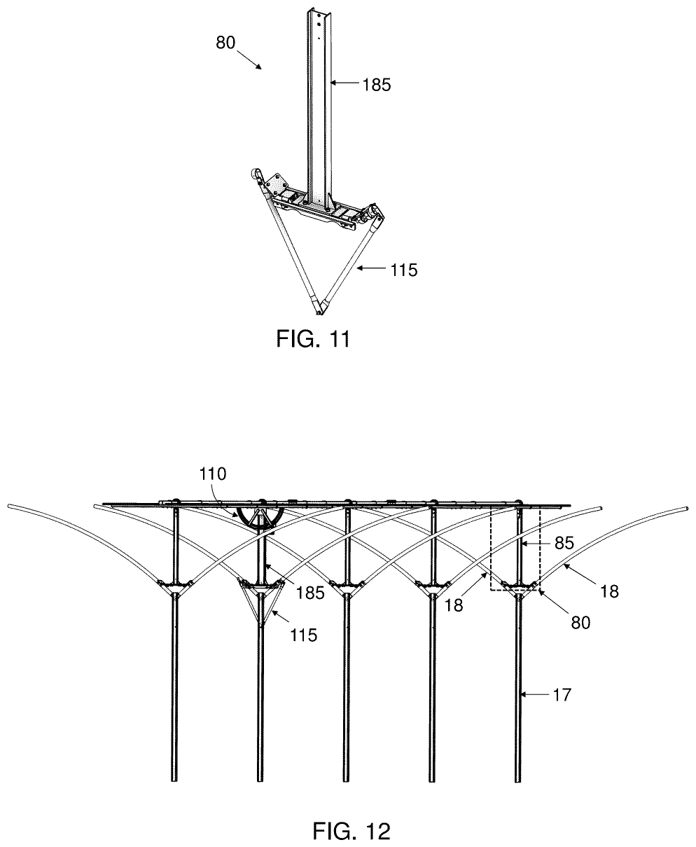

We now refer to FIGS. 11 and 12. According to some embodiments, the load-bearing support sub-assembly 80 to which the drive system 110 of the PV assembly 57 is mounted comprises a primary support member 185 that is larger in at least one transverse cross-sectional dimension than respective primary support members 85 of at least some, or in some embodiments all, of the other load-bearing support subassemblies 80 of the PV assembly 57. The more robust primary support member 185 is more resistant to torque and/or other forces generated by the drive system 110 and applied to the load-bearing support assembly 80. FIG. 11 shows a load-bearing support assembly 80 comprising the more robust primary support member 185. In some embodiments, such an enhanced load-bearing support sub-assembly 80 can additionally comprise a pair of struts 115 for providing additional stability when attached to a pair of opposing structural ribs 18 of adjoining or adjacent greenhouses 5, including for installation on greenhouses lacking support struts such as support struts 13 of FIG. 8. Integration of the support assembly 80 of FIG. 11 in a PV assembly 57 according to some embodiments is illustrated in FIG. 12, where the more robust primary support member 185 and struts 115 are employed for the load-bearing support assembly 80 to which components of the drive system 110 are mounted.

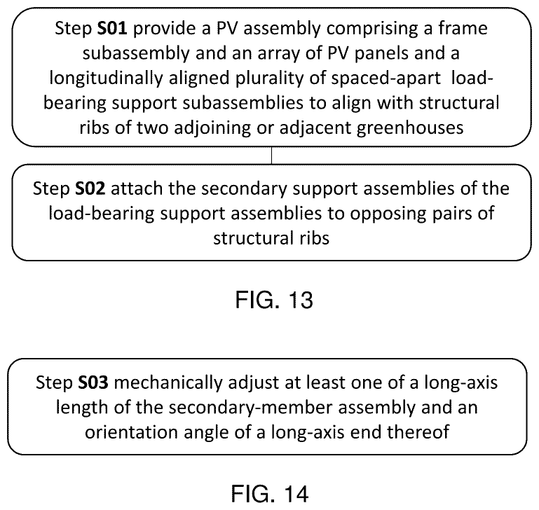

Referring now to FIG. 13, a method is disclosed for joining one or more PV assemblies to an array of laterally adjoining or adjacent greenhouses. As illustrated by the flow chart in FIG. 13, the method comprises at least the 2 method steps S01 and S02:

Step S01 includes: providing a PV assembly 57 comprising (i) a frame subassembly and an array of PV panels 55 joined thereto and pivotable therewith about a longitudinal axis 800 of the PV assembly 57, and (ii) a longitudinally aligned plurality of load-bearing support subassemblies 80 spaced apart longitudinally to align laterally with respective transverse structural ribs 18 of two adjoining or adjacent greenhouses 5. Each of the load-bearing support subassemblies includes (i) a primary support member 85 (or 185) pivotably coupled to the frame assembly, and (ii) a secondary support assembly 82 comprising a secondary support member 83 rigidly connected to the vertical member. In some embodiments, the primary support member 85, 185 is oriented vertically or within ±30° of vertical, the secondary support member 83 is horizontal or within ±30° of horizontal, and a long axis of the secondary support assembly 82 is transverse to the longitudinal axis or within ±30° of transverse.

Step S02 includes attaching the respective secondary support assemblies 82 of the load-bearing support assemblies 80 to opposing pairs of structural ribs 18 of the two adjoining or adjacent greenhouses 5. In some embodiments, the attaching is effective to transfer the load of the entire weight of the frame subassembly and of the array of PV panels 55 joined thereto to the structural ribs 18.

In some embodiments, as illustrated by the flow chart in FIG. 14, the method additionally comprises Step S03. Step S03 additionally comprises mechanically adjusting at least one of a long-axis length of the secondary support assembly 82 and an orientation angle of a long-axis end thereof.

The skilled artisan will understand that use of the term ‘greenhouse’ herein is merely illustrative, and the disclosed embodiments are equally applicable to other types of adjoining or adjacent structures that are built around ribs, including structural ribs.

Terms such as ‘joined’, ‘coupled’, ‘attached’, ‘mounted’ and the like, when used herein, include both indirect and direct joining, coupling, attaching, mounting, etc., unless otherwise specified. It will be appreciated that the above descriptions are intended only to serve as examples, and that many other embodiments are possible within the scope of the present invention and as defined in the appended claims.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A photovoltaic (PV) assembly adapted for installation between laterally adjoining or adjacent greenhouses comprising respective longitudinally aligned pluralities of transverse structural ribs, the PV assembly comprising (i) a frame subassembly and an array of PV panels joined thereto and pivotable therewith about a longitudinal axis of the PV assembly, and (ii) a longitudinally aligned plurality of load-bearing support subassemblies, each configured for attachment to a respective pair of opposing structural ribs of the adjoining or adjacent greenhouses.

2. The PV assembly of claim 1, wherein attachment of the plurality of load-bearing support subassemblies to respective pairs of opposing structural ribs is effective to transfer a portion of the weight of the PV assembly to the structural ribs.

3. The PV assembly of claim 1, wherein attachment of the plurality of load-bearing support subassemblies to respective pairs of opposing structural ribs is effective to transfer the entire weight of the PV assembly to the structural ribs.

4. The PV assembly of claim 1, wherein each of the load-bearing support subassemblies includes (i) a primary support member pivotably coupled to the frame assembly and, and (ii) a secondary support assembly comprising a secondary support member rigidly connected to the primary support member and configured for attachment to the respective pair of opposing structural ribs.

5. The PV assembly of claim 4, wherein the primary support member is oriented vertically or within ±30° of vertical, the secondary support member is oriented horizontally or within ±30° of horizontal, and a long axis of the secondary support assembly is oriented transversely to the longitudinal axis or within ±30° of transverse.

6. The PV assembly of claim 4, wherein at least one of a long-axis length of the secondary support assembly and an orientation angle of a long-axis end thereof is mechanically adjustable.

7. The PV assembly of claim 1, wherein the plurality of load-bearing support subassemblies collectively support the frame subassembly and the array of PV panels joined thereto.

8. The PV assembly of claim 1, comprising a drive system mounted to a selected one of the load-bearing support subassemblies and operative when powered to pivot the frame subassembly and the array of PV panels joined thereto, wherein the primary support member of the selected one of the load-bearing support subassemblies is larger in at least one transverse cross-sectional dimension than respective primary support members of all other load-bearing support subassemblies of the plurality of load-bearing support subassemblies.

9. A PV assembly comprising (i) a frame subassembly and an array of PV panels joined thereto and pivotable therewith about a longitudinal axis of the PV assembly, and (ii) a longitudinally aligned plurality of load-bearing support subassemblies, each load-bearing support subassembly comprising:
i. a vertical member pivotably coupled to the frame assembly, and
ii. a horizontal-member assembly comprising a horizontal member rigidly connected to the vertical member such that a long axis of the horizonal-member assembly is transverse to the longitudinal axis, at least one of a length of the horizontal-member assembly and an orientation angle of a laterally disposed end thereof being mechanically adjustable.

10. A method of joining one or more PV assemblies to an array of laterally adjoining or adjacent greenhouses, the method comprising:
a. providing a PV assembly according to claim 1, wherein each of the load-bearing support subassemblies includes (i) a primary support member pivotably coupled to the frame assembly, and (ii) a secondary support assembly comprising a secondary support member rigidly connected to the vertical member; and
b. attaching the respective secondary support assemblies of the load-bearing support assemblies to opposing pairs of structural ribs of the two adjoining or adjacent greenhouses.

11. The method of claim 10, wherein the attaching is effective to transfer the load of the entire weight of the frame subassembly and of the array of PV panels joined thereto to the structural ribs.

12. The method of claim 10, wherein the primary support member is oriented vertically or within ±30° of vertical, the secondary support member is horizontal or within ±30° of horizontal, and a long axis of the secondary support assembly is transverse to the longitudinal axis or within ±30° of transverse.

13. The method of claim 10, additionally comprising: mechanically adjusting at least one of a long-axis length of the secondary support assembly and an orientation angle of a long-axis end thereof.

14. A structural arrangement comprising:
a. an array of laterally adjoining or adjacent greenhouses comprising respective longitudinally aligned pluralities of transverse structural ribs; and
b. a PV assembly comprising (i) a frame subassembly and an array of PV panels joined thereto and pivotable therewith about a longitudinal axis of the PV assembly, and (ii) a longitudinally aligned and spaced-apart plurality of load-bearing support subassemblies each including a vertical member pivotably coupled to the frame assembly and rigidly connected to a horizontal member of a horizontal-member assembly, the rigid connection being such that a long axis of the horizonal-member assembly is transverse to the longitudinal axis, wherein the respective horizontal-member assemblies of the load-bearing support assemblies are attached to opposing structural ribs of two adjoining or adjacent greenhouses, the attachment being such that the weight of the PV assembly is supported by the structural ribs.
